(19) United States
(12) Patent Application Publication
(10) Pub. No.: US 2011/0168040 A1
(43) Pub. Date: Jul. 14, 2011

(54) METHOD AND APPARATUS FOR TRANSFER PRINTING, AND PRINTED ARTICLES MANUFACTURED BY SAME

(76) Inventor: Pan Soo Seo, Seoul (KR)

(21) Appl. No.: 12/737,641

(22) PCT Filed: Jul. 27, 2009
(86) PCT No.: PCT/KR2009/004158

§ 371 Date: Mar. 30, 2011

(30) Foreign Application Priority Data
Aug. 14, 2008 (KR) 10-2008-0079982

(51) Int. Cl. B41F 7/02

(52) U.S. Cl. 101/217; 101/483

(57) ABSTRACT

The invention provides a transfer printing (coating) method, a transfer printing (coating) apparatus, and a printing article manufactured by the same. The transfer printing (coating) apparatus is adapted to achieve high quality printing and coating on a rough and unglazed surface, and includes: a blanket; a plurality of feed rollers installed along a feed direction of the blanket and configured to aid feeding of the blanket; a blanket printing unit configured to print an image on one surface of the blanket; a mixed solution applying unit configured to apply a mixed solution containing ink and nylon powder on. an image ink layer of the blanket; a printing substrate; a printing substrate printing unit configured to attach the ink and the nylon powder applied on the blanket to the printing substrate by thermally pressing the blanket to one surface of the printing substrate; and a printing body configured to accommodate the printing substrate printed by the printing substrate printing unit.

### TECHNICAL FIELD

The present invention relates to a transfer printing (coating) method, a transfer printing (coating) apparatus, and a printing article (coating article) manufactured by the same, and more particularly to a technology of achieving high quality printing and coating on a rough and unglazed surface at a high speed.

### BACKGROUND ART

In general, images are printed on a surface of paper for public relations wordings or decorations of a manufacturer by using a printing apparatus.

Such printings are achieved by a variety of methods according to materials or characteristics of printing substrates such as paper. Meanwhile, when a surface of a printing substrate is not smooth like in a packing box or recycled paper, printing quality deteriorates, failing to satisfy visual satisfaction.

In particular, in a conventional transfer printing method, after an image area is formed by applying a release agent to a surface of a plastic film or paper through a gravure printing method to form a release layer and applying an ink layer on the release layer, an image is printed by applying an adhesive to the image area and applying heat to it.

However, in the conventional transfer printing method, as transfer paper is cut into a predetermined size to be used in a sheet form, there is a limit in reusing the transfer paper, which is non-economical and inefficient.

That is, a plastic film formed as a release layer or release paper is wasted and disposed after being used once or twice, consumption of resources is severe and the prices of printing articles increase.

Besides, as the method requires a number of manual works, it is impossible to repeat high speed transfers and products are not uniform, making the quality of the printing substrate non-uniform.

Meanwhile, according to a general printing method except for the transfer method, as a surface of high-quality art paper which is neither uniform nor smooth and whose background color has a tan color or a dark color cannot be directly printed, a yellow paper board is integrated with high-quality art paper via a process of color-printing and coating a picture on the high-quality art paper to perform a post-machining process, which is bothersome and consumes much time and material.

Meanwhile, coating related to paper printing generally includes over-coating, laminating coating, and UV coating.

The object of over-coating is to obtain a printing article on which a transparent coating liquid is applied and coated. Laminating coating is adapted to obtain a glazed or unglazed printing article by applying a transparent adhesive to a transparent OPP film or other plastics on the printing article to be coated and bonding it to the printing article. UV coating is adapted to obtain a glazed printing article by applying a UV coating liquid on the printing article to be coated and irradiating light using an UV lamp to harden the coating liquid in a short time.

However, according to the three coating methods, while a flattened high-quality printing article can be glazed, a rough-surfaced printing article such as vellum paper or recycled paper cannot be glazed and is difficult to obtain a high-quality surface.

Moreover, the laminating coating method requires an OPP film or other plastic films.

### DISCLOSURE

### Technical Problem

Therefore, the present invention has been made in view of the above-mentioned problems, and the present invention provides a printing method, a printing apparatus, and a printing article in which even a rough-surfaced printing article can be glazed and have a high quality.

The present invention also provides a technology of providing a highly-glazed clear printing article even without performing separate coating when its background has a dark color such as in a yellow paper board.

The present invention further provides an economical technology by eliminating the necessity of an OPP coating film or other plastic films.

The present invention still provides a coating apparatus and a coating article in which a rough coating article can be glazed and have a high quality.

### Technical Solution

In accordance with an aspect of the present invention, there is provided a transfer printing method including: an image layer forming step of applying an image to be printed on a printing substrate on a surface of a blanket; a transfer layer forming step of applying a mixed solution containing an ink and nylon powder or a dry adhesive on an image layer formed in the image layer forming step; and a printing step of bringing the surface of the blanket having the image layer and a transfer layer into contact with the printing substrate to performing a printing operation.

Preferably, the blanket may be made of one material selected from a plastic including oriented polypropylene (OPP) or PET (polyethylene terephthalate) having low surface energy, a synthetic resin, silicon, stainless steel, and aluminum.

Preferably, the mixed solution may be made by mixing nylon powder having a powder degree of 70 or higher and polyvinyl chloride (PVC) ink at a ratio of 1:4 to 1:6.

In accordance with another aspect of the present invention, there is provided a transfer printing apparatus including: a blanket printing unit configured to form an image ink layer on a blanket on which an image is printed or on a surface of the blanket; a transfer layer forming unit configured to apply a mixed solution containing an ink and nylon powder or a dry adhesive on one surface of the blanket; and a printing substrate printing unit configured to print the image formed on the blanket on the printing substrate.

Preferably, the blanket may be formed in an endless orbit, or one side of the blanket may be released from a releasing roller and an opposite side of the blanket may be wound on a winding roller.

Preferably, the transfer layer forming unit may include: a tank in which a mixed solution of an ink and nylon powder or an adhesive is accommodated; a roller configured to apply the mixed solution or the adhesive on the surface of the blanket by rotation thereof; a doctor blade configured to flatten a surface of the roller; and a press cylinder roller engaged with the roller to be rotated. In this case, the blanket may pass between the roller and the press cylinder roller.

Preferably, the printing substrate printing unit may include: an attaching roller; and a thermal press roller. In this case, the printing substrate and the blanket may simultaneously pass between the attaching roller and the thermal press roller and a surface temperature of the thermal press roller may be 120 to 150 degrees Celsius.

Preferably, the blanket may be made of one material selected from a plastic including oriented polypropylene (OPP) or PET (polyethylene terephthalate) having low surface energy, a synthetic resin, silicon, stainless steel, and aluminum.

Preferably, the transfer printing apparatus may further include: an integrating roller provided between the transfer layer forming unit and the printing substrate printing unit and configured to integrate the blanket on which an image is printed and the printing substrate.

Preferably, the transfer printing apparatus may further include: a separating roller provided a downstream side of the printing substrate printing unit and configured to separate the printing substrate from the blanket integrated by the integrating roller and printed by the printing substrate printing unit.

Preferably, the transfer printing, apparatus may further include: a washing unit provided on a downstream side of the separating roller and configured to wash residual materials left on the surface of the blanket after the blanket has passed through the printing substrate printing unit.

Preferably, the washing unit may include: a washing liquid tank in which a washing liquid is accommodated; a pair of washing liquid feeding rollers configured to attach the washing liquid accommodated in the washing liquid tank to a surface of the blanket by rotations thereof; and a pair of washing rollers engaged with the washing liquid feeding rollers to be rotated and configured to attach the washing liquid to a surface of the blanket. In this case, the blanket may pass between the washing rollers.

Preferably, the washing unit may further include washing cloth and the blanket which has passed between the washing rollers may pass by the washing cloth.

In accordance with still another aspect of the present invention, there is provided a transfer coating apparatus including: a plurality of feed rollers installed along a feed direction of the blanket and configured to aid feeding of the blanket; a coating liquid applying unit configured to coat a coating liquid on one surface of the blanket; an adhesive applying unit configured to apply a transparent dry adhesive on the surface of the blanket; and a coating article coating unit configured to attach the coating liquid applied on the blanket and the transparent dry adhesive to a coating article by thermally pressing the blanket to one surface of the coating article.

In accordance with still another aspect of the present invention, there is provided a printing article manufactured by a transfer printing method according to the present invention, a transfer printing apparatus according to the present invention, or a transfer coating apparatus according to the present invention.

### Advantageous Effects

According to the present invention, there may be provided a printing or coating apparatus that achieves high-quality printing or coating of rough recycled paper or a packing box in a glazed sate.

That is, according to the present invention, as an image of a blanket is printed on a printing article by a transfer layer by forming an image layer on the blanket and forming the transfer layer on the blanket, highly glazed high-quality coating can be achieved on a printing article having a dark background or a rough surface.

In particular, as the blanket according to the present invention is made of one material selected from a plastic including oriented polypropylene (OPP) or PET (polyethylene terephthalate) having low surface energy, a synthetic resin, silicon, stainless steel, and aluminum, an image of the blanket can be easily transferred to the printing substrate. Further, as an ink layer is formed on a surface of the blanket having low surface energy, the blanket can be easily separated from the printing substrate after integration of them. Furthermore, even a rough or dark surface can be clearly transferred.

Further, as the mixed solution is made by mixing nylon powder having a powder degree of 70 or higher and polyvinyl chloride (PVC) ink at a ratio of 1:4 to 1:6, an image can be easily transferred to the printing substrate.

Furthermore, as a water-soluble acryl dry adhesive is used instead of a mixed, solution, an image can be easily and promptly transferred to the printing substrate.

According to the present invention, there is provided a printing apparatus including a blanket printing unit, a transfer layer forming unit, and a printing substrate printing unit, in which case even a printing substrate of low quality can be printed at a high quality.

According to the present invention, the transfer layer forming unit includes: a tank in which a mixed solution of an ink and nylon powder or an adhesive is accommodated; a roller configured to apply the mixed solution or the adhesive on the surface of the blanket by rotation thereof; a doctor blade configured to flatten a surface of the roller; and a press cylinder roller engaged with the roller to be rotated, the blanket passing between the roller and the press cylinder roller, whereby an image can be easily transferred to the printing substrate.

According to the present invention, the printing substrate printing unit includes an attaching roller and a thermal press roller. In particular, the thermal press roller has a surface temperature of 120 to 150 degrees Celsius, whereby an image can be attached and printed on the printing substrate.

According to the present invention, the blanket is formed in an endless orbit, or one side of the blanket is released from a releasing roller and an opposite side of the blanket is wound on a winding roller, whereby printing is performed in various forms.

According to the present invention, an integrating roller is installed between the transfer layer forming unit and the printing substrate printing unit, whereby the blanket on which an image is printed and the printing substrate are easily integrated with each other.

According to the present invention, there is provided a separating roller provided on a downstream side of the printing substrate printing unit and configured to separate the printing substrate from the blanket integrated by the integrating roller and printed by the printing substrate printing unit, whereby the blanket to which an image has been transferred can be reused.

In particular, a washing unit provided on a downstream side of the separating roller and configured to wash residual materials left on the surface of the blanket after the blanket has passed through the printing substrate printing unit provides a technology of repeatedly using the blanket as in the initial state even after the blanket is partially stained with an ink or a contaminant while the image is being transferred.

That is, the washing unit includes a washing liquid tank, washing liquid feeding rollers, washing rollers, the blanket passing though the washing roller, whereby the wet blanket is clearly wiped away by the washing cloth, making it possible to continuously reuse the used blanket.

That is, although continuous printing is impossible according to the conventional technology, a blanket according to the present invention can be reused after an image layer is formed on the blanket and is integrated with a printing substrate, the image layer of the blanket is transferred to the printing substrate, and the blanket and the printing substrate are separated from each other, whereby the present invention can provide a technology of performing continuous printings instead of a conventional printing technology of performing printings one by one.

According to the present invention, while an image ink layer may be formed on one surface of the blanket through the blanket printing unit, a series of processes, e.g. a transfer layer forming process using a bracket on which an image is already printed and a printing substrate printing process may be performed, whereby a blanket printed using a conventional apparatus can be combined with the technology according to the present invention, which is economical and useful.

According to the present invention, there is provided a coating apparatus including a blanket, a blanket feeding roller, a coating liquid applying unit, an adhesive applying unit, and a coating article coating unit, whereby a highly glossed high-quality coating becomes possible even on a rough coating article.

According to the present invention, there is also provided a printing article manufactured by a transfer printing method according to the present invention, a transfer printing apparatus according to the present invention, or a transfer coating apparatus according to the present invention, whereby a highly glossed high-quality printing (coating) article can be achieved even when the printing surface is rough recycled paper, or has a dark background color.

### BRIEF DESCRIPTION OF THE DRAWINGS

The foregoing and other objects, features and advantages of the present invention will become more apparent from the following detailed description when taken in conjunction with the accompanying drawings in which:

FIG. 1 is a systematic diagram of a printing apparatus according to the first embodiment of the present invention;

FIG. 2 is a view illustrating a modified example of FIG. 1;

FIG. 3 is a systematic diagram of a printing apparatus according to the second embodiment of the present invention;

FIG. 4 is a view illustrating a modified example of FIG. 3;

FIG. 5 is a systematic diagram of a blanket printing apparatus;

FIG. 6 is a systematic diagram of a printing apparatus according to the third embodiment of the present invention; and

FIG. 7 is a coating apparatus according to the fourth embodiment of the present invention.

### BEST MODE

### Mode for Invention

Hereinafter, exemplary embodiments of the present invention will be described with reference to the accompanying drawings.

In the following description of the present invention, a detailed description of known functions and configurations incorporated herein will be omitted when it may make the subject matter of the present invention rather unclear. The following terms used herein consider their functions in the present invention and may be different according to the intensions or customs of manufacturers. Thus, the definitions of the terms should be made based on the contents of the entire specification.

### Embodiment 1

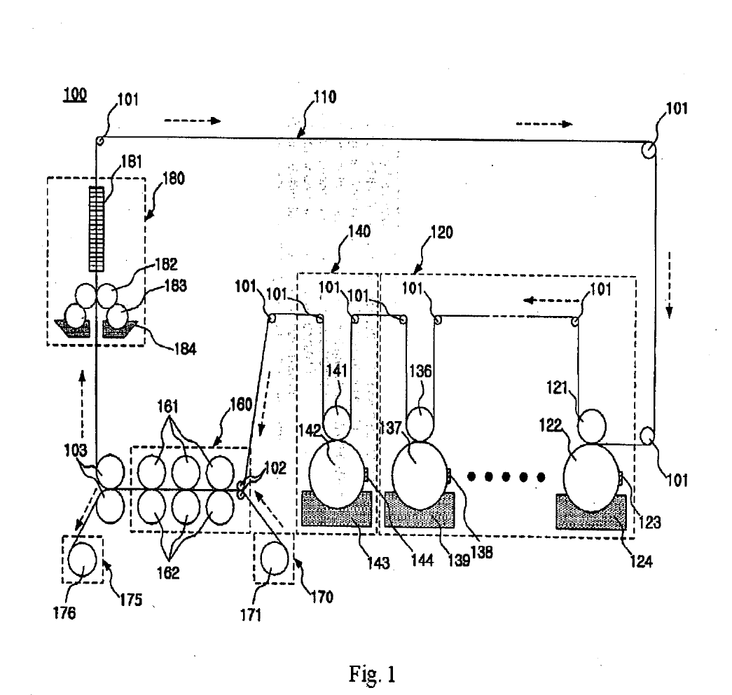

First, a transfer printing apparatus according to the first embodiment of the present invention will be described with reference to FIG. 1.

FIG. 1 is a systematic diagram of a printing apparatus according to the first embodiment of the present invention.

As illustrated in FIG. 1, a transfer printing apparatus (hereinafter, briefly referred as ‘a printing apparatus’ for convenience’ sake) 100 includes a blanket 100, a plurality of feed rollers 101, a blanket printing unit 120, a transfer layer forming (mixed solution applying) unit 140, a printing substrate printing unit 160, a printing substrate 170, a printing body 175, and a washing unit 180.

The blanket 110 receives printing ink from a cylinder and transfers it to the printing substrate 170 while making a printing pressure uniform, and functions to feed an ink layer of an image that will be printed on the printing body 170.

The blanket 110 is formed in an endless orbit and is made of one material selected from a plastic such as oriented polypropylene (OPP) or PET (polyethylene terephthalate) having low surface energy and whose bonding force with a printing ink or an adhesive is very weak, a synthetic resin, silicon, stainless steel, and aluminum.

Meanwhile, as the blanket 110 of the present invention needs to be repeatedly used regardless of its type, e.g. either an endless orbit type or a roll type, it requires durability even after its repeated use, in which case several sheets of OPP films may be integrated and used when they are thin.

For example, in case of OPP films each having a thickness of 0.05 mm, two sheets of OPP films may be integrated to have a thickness of 0.1 mm. Then, they may have a width of 60 cm and a length of 80 m.

However, it is apparent that dimensions of the blanket are merely an example and the dimensions of an endless orbit type or roll type blanket may become different according to the chromaticity of a printing machine, the type, size, and thickness of a printing substrate.

The plurality of feed rollers 101 are installed along a feed direction of the blanket 110 to aid feeding of the blanket 110.

The blanket printing unit 120 forms an image on one surface of the blanket 110.

In the blanket printing unit 120, an ink is accommodated in an ink liquid tank 124. The printing cylinder roller 122 applies the ink of an image on a surface of the blanket 110 while rotating.

A doctor blade 123 wipes away excessive ink on a non-image area of a cylinder corroded by a gravure engraving method. A press cylinder roller 121 is engaged with the printing cylinder roller 122 to be rotated.

The ink of an image is printed on a surface of the blanket 110 while the blanket 110 press between the printing cylinder roller 122 and the press cylinder roller 121.

A plurality of sets of blanket printing units 120 may be used according to the kinds of colors.

The mixed solution applying unit 140 applies a mixed solution containing an ink and nylon powder on one surface of the blanket 110.

The mixed solution of the ink and the nylon powder is accommodated in a mixed solution tank 143. The mixed solution is preferably made by mixing nylon powder having a powder degree of 70 or higher and polyvinyl chloride (PVC) ink at a ratio of 1:4 to 1:6, and more preferably by mixing nylon powder having a powder degree of 80 and PVC ink at a ratio of 1:5.

As particles of an ink having a powder degree of below 70 become rough during transfer of the ink, a powder of 70 or higher is preferable.

If the ratio of nylon powder to PVC ink is below 1:4, bonding force becomes stronger than needed, making it difficult for an image to be separated from the blanket. On the other hand, if the ratio of nylon powder to PVC ink is above 1:6, bonding force becomes weaker, causing an image to be peeled from the blanket. Thus, it is preferable that nylon powder and PVC ink are mixed at a ratio of 1:4 to 1:6.

The mixed solution roller 142 applies a mixed solution on a surface of the blanket 110 during rotation thereof. The doctor blade 144 flattens a surface of the mixed solution roller 142.

The press cylinder roller 141 is engaged with the mixed solution roller 142 to be rotated. The blanket 110 passes between the mixed solution roller 142 and the press cylinder roller 141, in which case a mixed solution is printed on a surface of the blanket 110. The printing substrate 170 may be paper wound on the printing substrate roll 171 or in a single sheet form.

The printing substrate 170 and the blanket 110 on which an image is printed are integrated by an integrating roller 102.

The printing substrate printing unit 160 attaches the ink and nylon powder applied on the blanket 110 to the printing substrate 170 by thermally pressing one surface of the integrated printing substrate 170 and the blanket 110. In the printing substrate printing unit 160, attaching rollers 162 interact with (press) press rollers 161.

The thermal press rollers 161 interact with the attaching rollers 162. The thermal press rollers 161 preferably have a surface temperature of 120 to 150 degrees Celsius.

This is because when the surface temperature of the thermal press rollers 161 is below 120 degrees Celsius, it is difficult for an image printed on the blanket 110 to be attached to a surface of the printing substrate 170, and when it is above 150 degrees Celsius, the rollers made of silicon may be damaged by the high temperature.

The ink and mixed solution of the blanket 110 is transferred to the printing substrate 170 while both the printing substrate 170 and the blanket 110 pass between the attaching rollers 162 and the thermal press rollers 161.

Then, the printing substrate 170 on which an image transferred from the blanket 110 has been printed and the blanket 170 integrated with the printing substrate 170 are separated by separating rollers 103.

Thus, the transfer printed printing substrate 170 is fed to the printing body 175, and the blanket 110 separated from the printing substrate 170 is fed to the washing unit 180 to be reused.

Meanwhile, the printing body 175 accommodates the printing substrate 170 printed by the printing substrate printing unit 160. The printing body 175 may be accommodated in the form of a printing body roll 175 or may be stacked in a sheet form.

The washing unit 180 washes residual materials left on the surface of the blanket 110 which has passed through the printing substrate printing unit 160. In the washing unit 180, a washing liquid is accommodated in a washing water tank 184. Preferably, toluene is used as the washing liquid.

A pair of washing liquid feeding rollers 183 applies the washing liquid accommodated in the washing liquid tank 184 on a surface of the blanket 110 by rotation thereof. A pair of washing rollers 182 is engaged with the washing liquid feeding rollers 183 to be rotated and applies the washing liquid on the surface of the blanket 110. The blanket 110 is washed by the washing liquid while passing between the washing rollers 182. The washing cloth 181 removes the residual washing liquid left on the blanket 110 which has passed between the washing rollers 182.

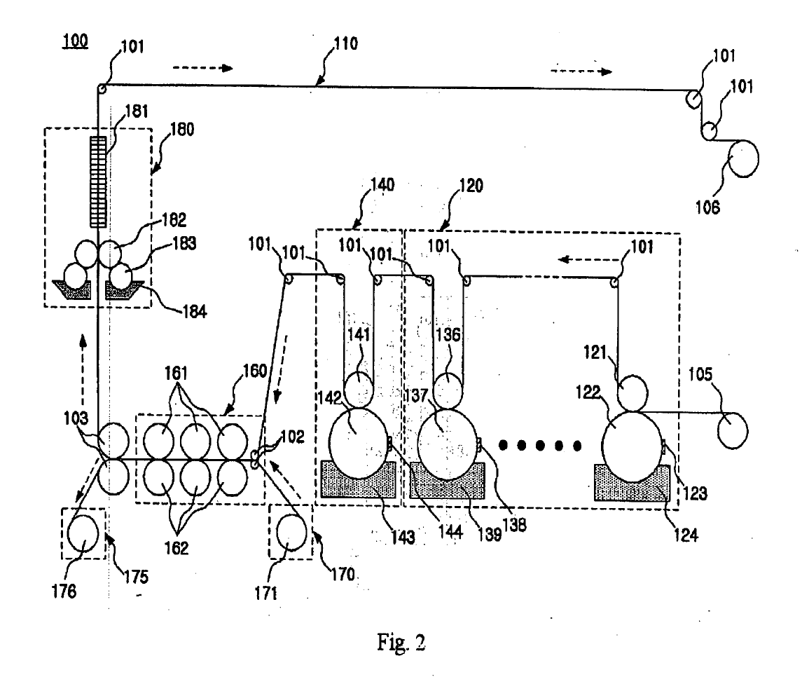

Hereinafter, a modified example of the first embodiment of the present invention will be described with reference to FIG. 2.

FIG. 2 illustrates a modified example of FIG. 1.

As illustrated in FIG. 2, the printing apparatus according to the modified example of the present invention is substantially the same except that one side of the blanket 110 is released from a releasing roller 105 and an opposite side of the blanket 110 is wound on a winding roller 106.

### Embodiment 2

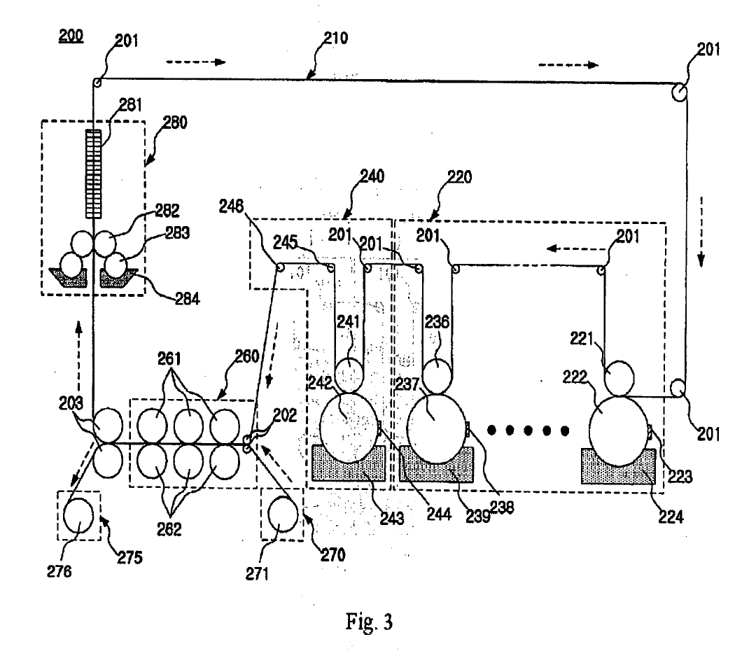

Hereinafter, a printing apparatus according to the second embodiment of the present invention will be described with reference to FIG. 3.

FIG. 3 is a systematic diagram of a printing apparatus according to the second embodiment of the present invention.

As illustrated in FIG. 3, the printing apparatus 200 according to the second embodiment of the present invention is substantially the same except that the transfer layer forming unit, i.e. the mixed solution applying unit 140 is replaced with an adhesive applying unit 240.

In the adhesive applying unit 240, a water-soluble dry adhesive is accommodated in the adhesive tank 243.

An adhesive roller 242 applies an adhesive on a surface of a blanket 210 by rotation thereof. The doctor blade 244 flattens a surface of the adhesive roller 242.

A press cylinder roller 241 is engaged with the adhesive roller 242 to be rotated. The adhesive of the adhesive roller 242 is applied on the surface of the blanket 210 while the blanket 210 passes between the adhesive roller 242 and the press cylinder roller 241.

Feed rollers 245 and 246 guide the blanket 210 which has passed between the adhesive roller 242 and the press cylinder roller 241 to a printing substrate printing unit 260. The feed rollers 245 and 246 are preferably formed of silicon having low surface energy so that the adhesive printed on the blanket 210 is prevented from being stuck to them.

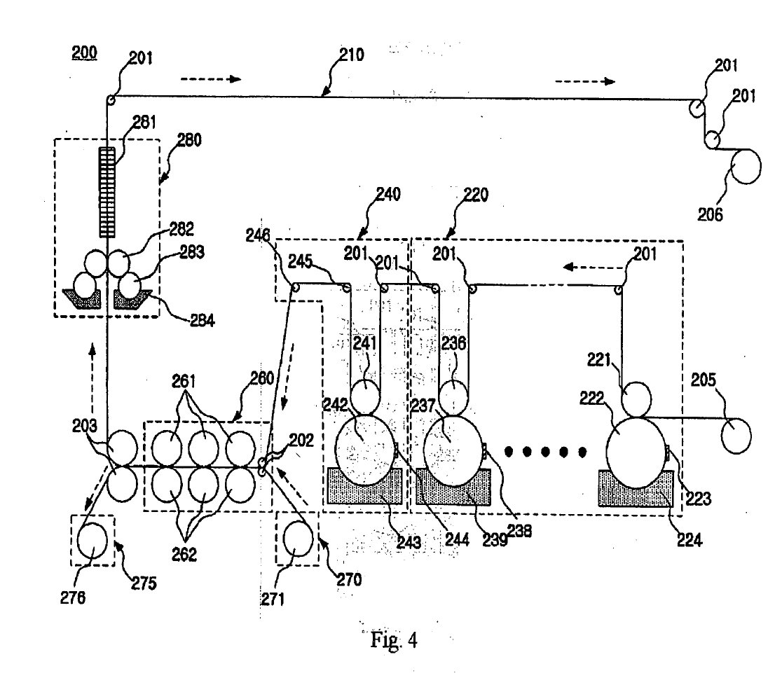

Hereinafter, a modified example of the second embodiment of the present invention will be described with reference to FIG. 4.

As illustrated in FIG. 4, the printing apparatus according to the modified example of the present invention is substantially the same except that one side of the blanket 210 is released from a releasing roller 205 and an opposite side of the blanket 210 is wound on a winding roller 206.

### Embodiment 3

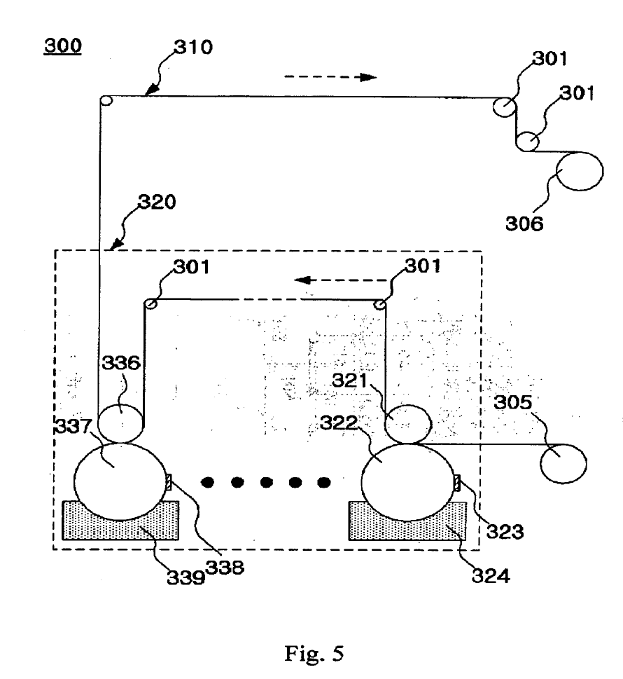

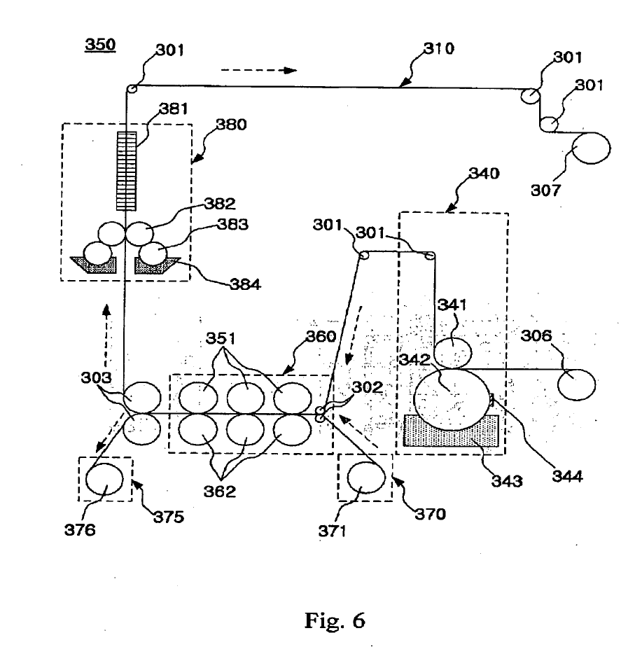

Hereinafter, a printing apparatus according to the third embodiment of the present invention will be described with reference to FIGS. 5 and 6.

FIG. 5 is a systematic diagram of a blanket printing apparatus. FIG. 6 is a systematic diagram of a printing apparatus according to the third embodiment of the present invention.

As illustrated in FIGS. 5 and 6, the printing apparatus 350 according to the third embodiment of the present invention is used in the case of not including an apparatus for printing a blanket 310.

The blanket 310 is prepared in a state in which an image is printed on a surface of the blanket 310 by the blanket printing apparatus 300 of FIG. 5.

Thereafter, the blanket 310 is installed at a releasing roller 306 and a winding roller 307 of the printing apparatus 350 to perform a transfer printing operation.

### Embodiment 4

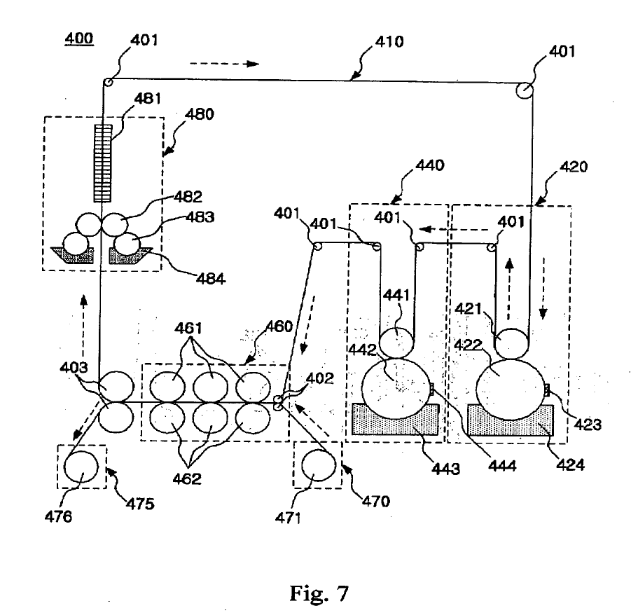

Hereinafter, a transfer coating apparatus according to the fourth embodiment of the present invention will be described with reference to FIG. 7.

FIG. 7 is a coating apparatus according to the fourth embodiment of the present invention.

As illustrated in FIG. 7, in a transfer coating apparatus (hereinafter, briefly referred to as ‘a coating apparatus’ for convenience’ sake) 400, a coating liquid applying unit 420 applies a coating liquid on one surface of the blanket 410. An adhesive applying unit applies a transparent dry adhesive on the surface of the blanket 410.

### INDUSTRIAL APPLICABILITY

Although several exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1-15. (canceled)

16. A method of transfer printing, the process is comprising the steps of:
applying an image to be printed on a printing substrate on a surface of a blanket;
mixing a solution contained an ink and nylon powder or a dry adhesive and apply on an image layer formed in above step; and
bringing the surface of the blanket having the image layer and a transfer layer into contact with the printing substrate to perform a printing operation.

17. The method as claimed in claim 16, wherein the blanket is made of one material selected from a plastic including oriented polypropylene (OPP) or PET (polyethylene terephthalate) having low surface energy, a synthetic resin, silicon, stainless steel, and aluminum.

18. The method as claimed in claim 17, wherein the mixed solution is made by mixing nylon powder having a powder degree of 70 or higher and polyvinyl chloride (PVC) ink at a ratio of 1:4 to 1:6.

19. An apparatus of transfer printing, comprising:
a blanket printing unit configured to form an image ink layer on a blanket on which an image is printed or on a surface of the blanket;
a transfer layer forming unit configured to apply a mixed solution containing an ink and nylon powder or a dry adhesive on one surface of the blanket; and
a printing substrate printing unit configured to print the image formed on the blanket on the printing substrate.

20. The apparatus, as claimed in claim 19, wherein the blanket is formed in an endless orbit, or one side of the blanket is released from a releasing roller and an opposite side of the blanket is wound on a winding roller.

21. The apparatus, as claimed in claim 20, wherein the transfer layer forming unit includes:
a tank in which a mixed solution of an ink and nylon powder or an adhesive is accommodated;
a roller configured to apply the mixed solution or the adhesive on the surface of the blanket by rotation thereof;
a doctor blade configured flatten a surface of the roller; and
a press cylinder roller engaged with the roller to be rotated, and
wherein the blanket passes between the roller and the press cylinder roller.

22. The apparatus, as claimed in claim 21, wherein the printing substrate printing unit includes:
an attaching roller; and
a thermal press roller, and
wherein the printing substrate and the blanket simultaneously pass between the attaching roller and the thermal press roller and a surface temperature of the thermal press roller is 120 to 150 degrees Celsius.

23. The apparatus, as claimed in claim 21, wherein the blanket is made of one material selected from a plastic including oriented polypropylene (OPP) or PET (polyethylene terephthalate) having low surface energy, a synthetic resin, silicon, stainless steel, and aluminum.

24. The apparatus, as claimed in claim 21, further comprising:
an integrating roller provided between the transfer layer forming unit and the printing substrate printing unit and configured to integrate the blanket on which an image is printed and the printing substrate.

25. The apparatus, as claimed in claim 24, further comprising:
a separating roller provided at a downstream side of the printing substrate printing unit and configured to separate the printing substrate from the blanket integrated by the integrating roller and printed by the printing substrate printing unit.

26. The apparatus, as claimed in claim 25, further comprising:
a washing unit provided on a downstream side of the separating roller and configured to wash residual materials left on the surface of the blanket after the blanket has passed through the printing substrate printing unit.

27. The apparatus, as claimed in claim 26, wherein the washing unit includes:
a washing liquid tank in which a washing liquid is accommodated;
a pair of washing liquid feeding rollers configured to attach the washing liquid accommodated in the washing liquid tank to a surface of the blanket by rotations thereof; and
a pair of washing rollers engaged with the washing liquid feeding rollers to be rotated and configured to attach the washing liquid to a surface of the blanket, and
wherein the blanket passes between the washing rollers.

28. The apparatus, as claimed in claim 27, wherein the washing unit further includes washing cloth and the blanket which has passed between the washing rollers passes by the washing cloth.

29. An apparatus of transfer printing, comprising:
a plurality of feed rollers installed along a feed direction of the blanket and configured to aid feeding of the blanket;
a coating liquid applying unit configured to coat a coating liquid on one surface of the blanket;
an adhesive applying unit configured to apply a transparent dry adhesive on the surface of the blanket; and
a coating article coating unit configured to attach the coating liquid applied on the blanket and the transparent dry adhesive to a coating article by thermally pressing the blanket to one surface of the coating article.
